(19) United States
(12) Patent Application Publication
(10) Pub. No.: US 2003/0044005 A1
(43) Pub. Date: Mar. 6, 2003

(54) Data scrambler

(76) Inventors: Eugene W. Lee, San Jose, CA (US); Peter Chang, Fremont, CA (US)

Correspondence Address: MARGER JOHNSON & MCCOLLOM PC, 1030 SW MORRISON STREET, PORTLAND, OR, 97205, US

(21) Appl. No.: 09/931,088

(22) Filed: Aug. 15, 2001

(51) Int. Cl. H04K 1/06

(52) U.S. Cl. 380/37

(57) ABSTRACT

A data scrambler receives a parallel array of input bits. An array of previously scrambled output bits are stored from a previous clock period. The array of previously scrambled output bits are applied to the parallel array of input bits during a same current clock period to generate a current array of scrambled output bits.

### BACKGROUND

FIG. 1 shows a traditional scrambler circuit 12 and a traditional de-scrambler circuit 14. The scrambler circuit 12 scrambles a serial data input stream 16 bit by bit. A first input bit is input into an Exclusive OR (XOR) gate 18. The 39^{th} polynomial X(39) and 58^{th} polynomial X(58) are XORed together by a XOR gate 20. The result from XOR 20 is XORed with the input bit 16 by XOR gate 18. The scrambled output is fed into a first D-flip-flop 22. Each clock cycle another bit is serially fed into the XOR gate 18 and the output sequenced through the series of D-flip-flops 22.

The de-scrambler circuit 14 works in a similar manner. The scrambled serial data stream 24 is sequenced bit by bit through a series of D-flip-flops 26. The 39^{th} polynomial X(39) is XOR'd with the 58^{th} polynomial X(58) by XOR gate 28. The result is XOR'd with the scrambled data bit 24 by XOR gate 30. The output from the XOR gate 30 is the de-scrambled serial bit stream that was originally fed into scrambler circuit 12.

This traditional serial scrambler/de-scrambler circuitry is too slow and complex for high speed data traffic. The present invention addresses this and other problems associated with the prior art.

### SUMMARY OF THE INVENTION

A data scrambler receives a parallel array of input bits. An array of previously scrambled output bits are stored from a previous clock period. The array of previously scrambled output bits are applied to the parallel array of input bits to generate an array of scrambled output bits during the same clock period.

### BRIEF DESCRIPTION OF THE DRAWINGS

FIG. 1 is a schematic diagram of a prior art serial data scrambler and de-scrambler.

FIG. 2 is a block diagram of a parallel scrambler circuit.

FIG. 3 is a list of new seed values stored by the parallel scramble circuit.

FIG. 4 is a list of how the new seeds are applied to an input data array.

FIG. 5 shows an example of how the new seeds are determined for a particular input bit.

FIG. 6 shows another example of how the new seeds are determined for a different input bit.

FIG. 7 is a block diagram of a parallel de-scrambler circuit.

FIG. 8 is a block diagram showing how the parallel scrambler and de-scrambler circuits are used in a high speed network processor.

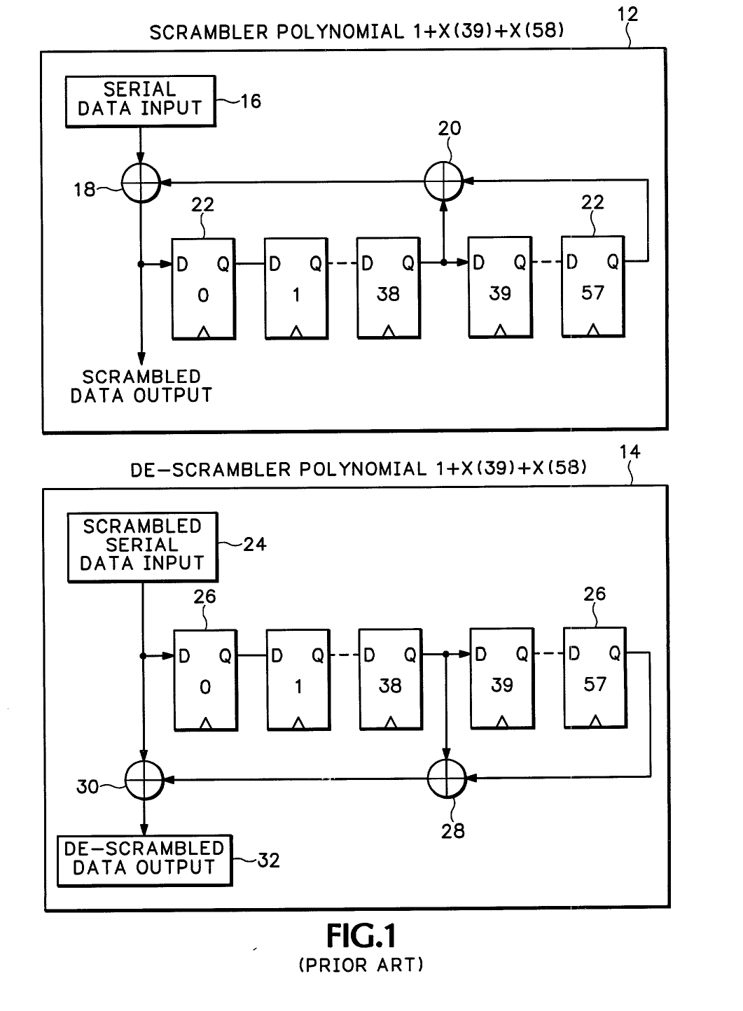

### DETAILED DESCRIPTION

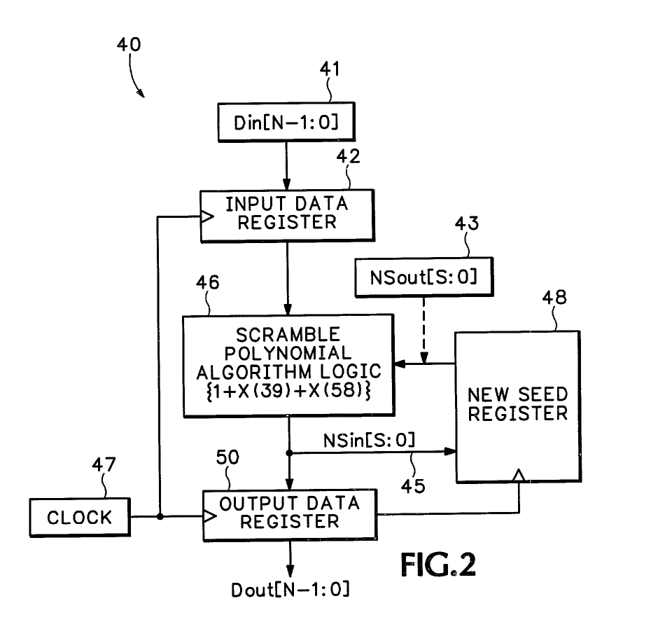

FIG. 2 shows a N-Bit parallel data scrambler 40. The scrambler 40 generates an array of new seed values that are used to generate an array of scramble polynomials that are applied in parallel to an array of input bits. This allows an array of scrambled bits to be generated during the same clock period. In the example below, the scramble polynomial 1+X(39)+X(58) is applied to a 64 bit array of input bits. However, any polynomial values can be used and applied to any bit length array of input bits using the scramble technique described below.

The parallel scrambler 40 reduces the complexity of previous scrambler designs and provides higher scrambling throughput simply by expanding the width of a data bus. The parallel scrambler 40 can be used in any data processing application and in one application is used for scrambling 10 gigabit network traffic.

Referring to FIG. 2, the N-bit parallel data scrambler 40 includes an input data register 42, scrambling logic 46, a new seed register 48, and an output data register 50. Any of these functional blocks may be implemented separately or together in software using a programmable processor device or using discrete logic devices.

After power up and enabling, the seed register 48 is loaded with a set of programmable seeds. An array of data from a parallel input data stream 41 is loaded into input data register 42 at the rising edge of a first clock period generated by clock 47. During a second clock period, the scrambler circuit 46 scrambles every bit from the parallel data bus 41 with the scramble polynomial 1+X(39)+X(58) using the pre-loaded new seed values 43 stored in seed register 48.

At the rising edge of the second clock period, the scrambled parallel data stream from scrambler circuit 46 is loaded into the output data register 50. At the same time, a new set of seed values 45 are loaded into the new seed register 48. A next array of bits from the parallel input data stream 41 are also loaded into the input data register 42. This process then repeats. The scrambling scheme can be easily adapted for any bit length.

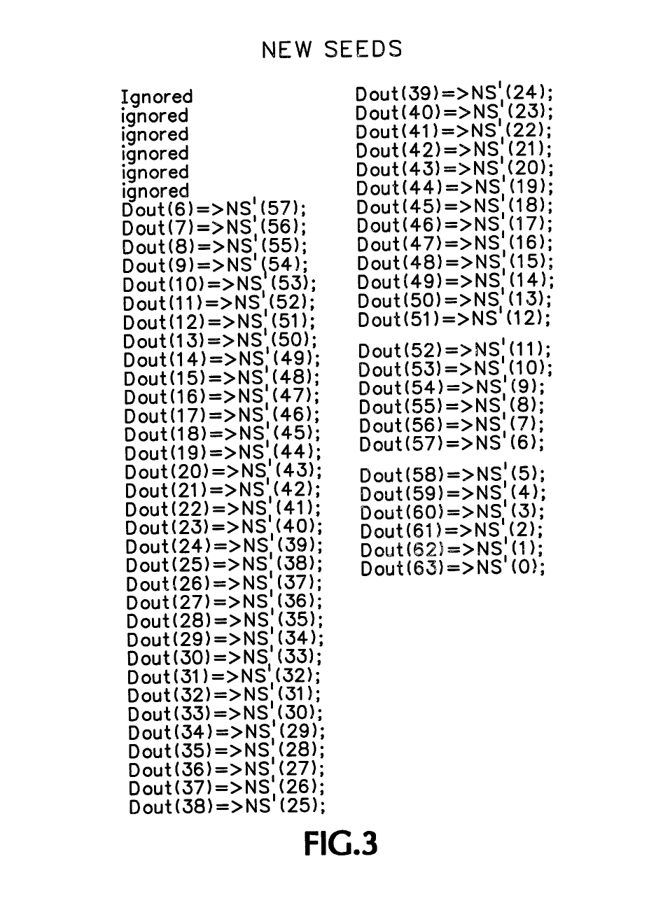

FIG. 3 shows the scrambled output values used for the new seed values 45 (FIG. 2). For example, the sixth scrambled output bit Dout(6) in a current clock period is loaded into the seed register 48 (FIG. 2) as the seed value NS′(57). The new seed value NS′(57) is used during the next clock period. The thirty ninth scrambled output bit Dout(39) generated during the current clock period is loaded into the seed register 48 as the next seed value NS′(24). The new seed values NS′(57)−NS′(0) are then used for scrambling a next array of input bits that are output from input data register 42 (FIG. 2) during a next clock period. The relationship between the new seed values and the scrambled output values for a parallel data bus width of N=64 is summarized below.

TABLE #1

NS[57:0] = Dout[M:N];
where, M = N − 58, and N = 64.

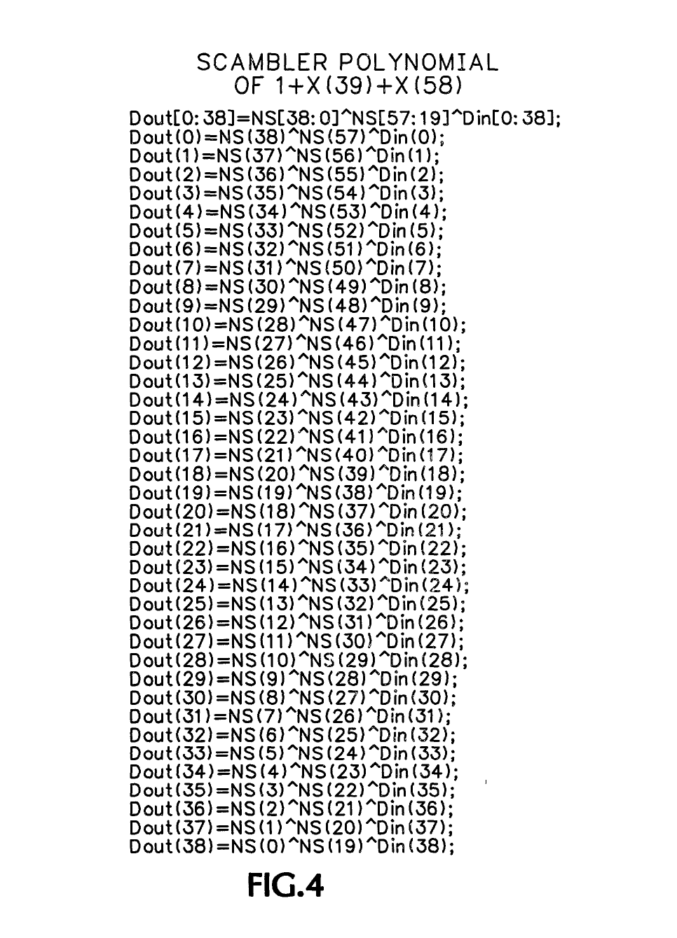

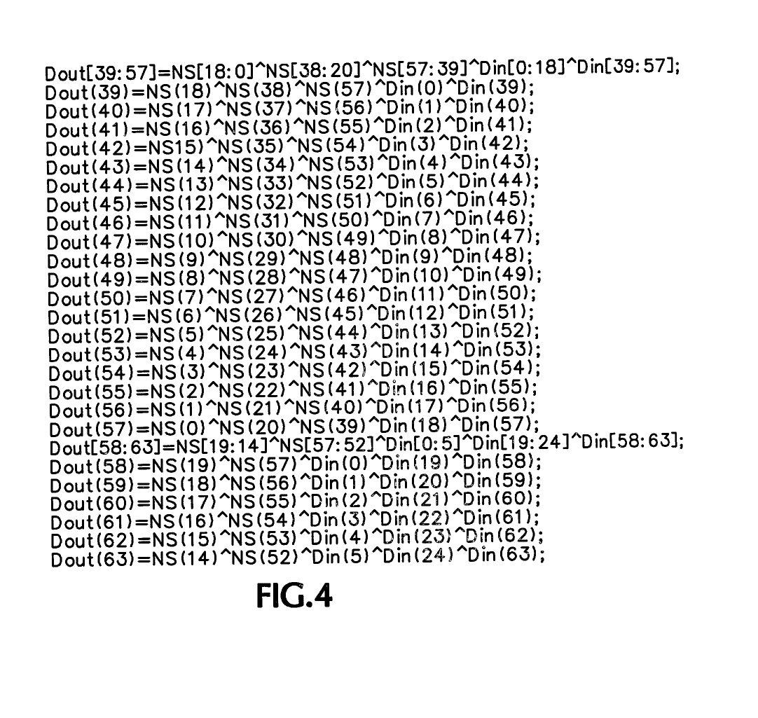

FIG. 4 shows how the different input bits are scrambled using the new seed bit values NS(57)−NS(0) from the new seed register 48 (FIG. 2). For a scramble polynomial of 1+X(39)+X(58), the scramble polynomial scheme is shown below in table #2. The symbol “ˆ ” refers to an exclusive OR function.

TABLE #2

Parallel Data Output Bits[0:38]:
Dout[0:38] = NS[38:0] ˆ NS[57:19] ˆ Din[0:38].
Parallel Data Output Bits[39:57]:
Dout[39:57] = NS[18:0] ˆ NS[38:20] ˆ NS[57:39] ˆ Din[0:18] ˆ Din[39:57].
Parallel Data Output Bits[58:N] (58 < N < 96):
Dout[58:N] = NS[19:14] ˆ NS[57:52] ˆ Din[0:5] ˆ Din[19:24] ˆ Din[58:63].

Referring to FIG. 4, a first scrambled output bit Dout(0) for a current clock period is generated by XORing new seed values NS(38), new seed value NS(57), and input bit value Din(0). The next scrambled output bit Dout(1) is generated by XORing new seed NS(37), new seed NS(56), and input bit value Din(1). The scrambling scheme changes for output bits Dout(39)−Dout(57). For example, Dout(45) is generated by XORing new seed NS (12), NS(32) and NS(51) and input bit values Din(6) and Din(45). A third scheme shown in FIG. 4 is used for scrambling output bits Dout(58)−Dout(63).

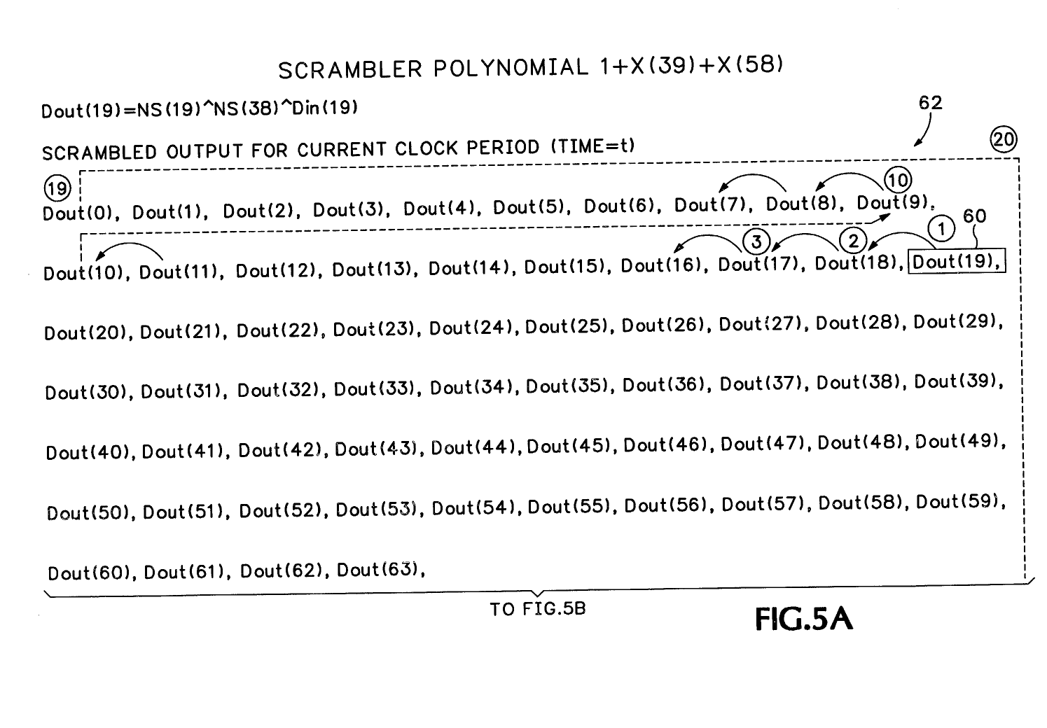

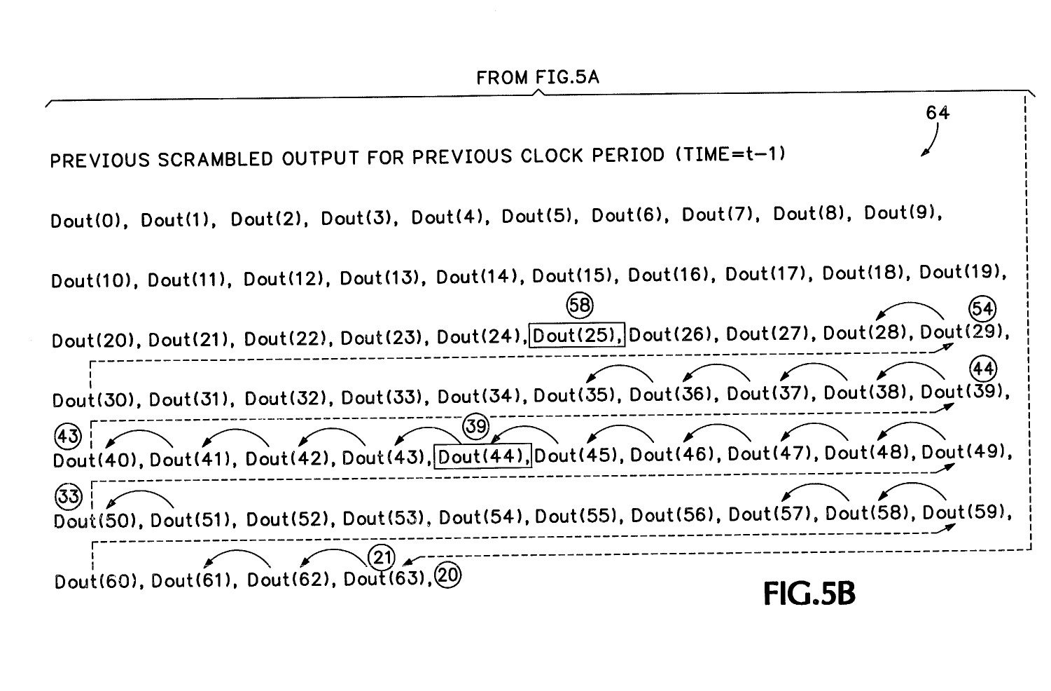

FIG. 5 further illustrates how the parallel scrambler circuit operates. The bits 62 represent the scrambled output bits generated for a current clock period t=t. The bits 64 represent the scrambled output bits generated for a previous clock period t=t−1. An output bit Dout(19) is identified as item 60 in FIG. 5. The polynomials X(39) and X(58) are determined for generating a scrambled output bit Dout(19) for input bit Din(19). For Dout(19), the polynomial X(39) is determined by counting back 39 previous scrambled output bit locations. For example, Dout(18) is one bit location, Dout(17) is a second bit location, etc.

After counting back 19 previous output bit locations to Dout(0), the scrambled output bits 64 for the previous clock period time t=t−1 are used. For example, the 20^{th} previous scrambled output bit location for Dout(19) is scrambled output bit Dout(63) from bits 64 generated during the previous clock period. Similarly, the 21^{st} previous scrambled output bit is Dout(62) from the previous clock period, output bits 64. The 39^{th} polynomial X(39) for Dout(19) is identified as Dout(44) from the previous clock period output bits 64. Counting back 58 positions from Dout(19), the 58^{th} polynomial X(58) is identified as scrambled output bit Dout(25) from the previous clock cycle output bits 64.

Referring back to FIGS. 3 and 4, Dout(44) from a current clock period t=t is stored in new seed location NS′(19) and Dout(25) is stored in new seed location NS′(38). Thus, the scrambler value used for applying the polynomial 1+X(39)+X(58) to generate Dout(19) is NS(19)ˆ NS(38)ˆ Din(19). Accordingly, the register location NS′(19) in new seed register 48 (FIG. 2) is loaded by the scrambler circuit 46 with the value Dout(44) and the new seed location NS′(38) in the new seed register 48 is loaded by the scrambler circuit 46 with the value Dout(25). The scrambler circuit 46 then XORs NS(19)ˆ NS(38)ˆ Din(19) to generate the scramble polynomial 1+X(39)+X(58) for Dout(19).

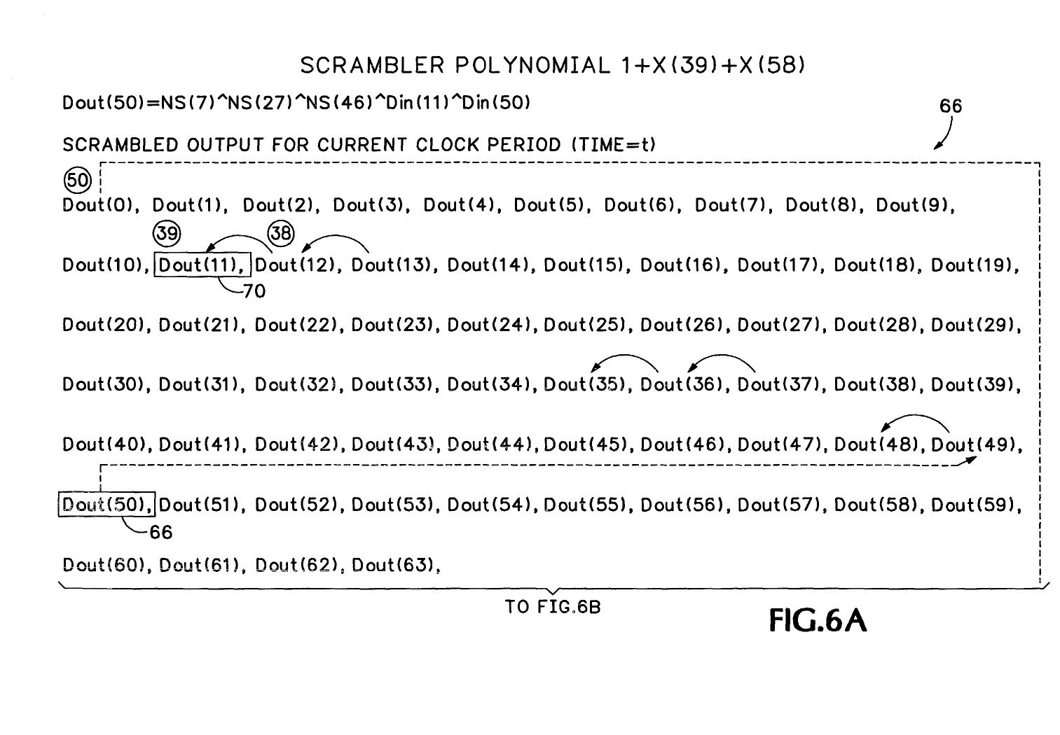

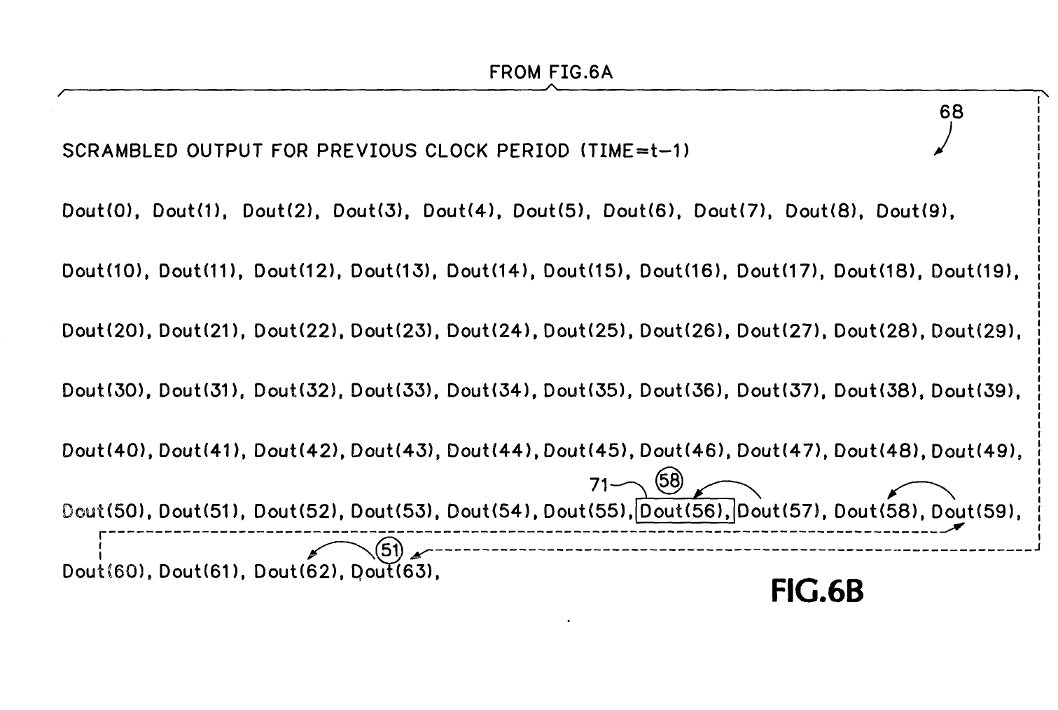

FIG. 6 shows an example of how the scrambled output value is generated for output bit Dout(50) identified as item 56. The scrambled value for Dout(50) is derived using the relationship NS(7)ˆ NS(27)ˆ NS(46)ˆ Din(11)ˆ Din(50). Bits 66 represent the scrambled output bits for a current clock period, and bits 68 represent the scrambled output bits for a previous clock period. The 39^{th} polynomial X(39) for Dout(50) is the scrambled output bit Dout(11) identified as item 70 in FIG. 6. The scrambled value Dout(11) is derived from the equation NS(27)ˆ NS(46)ˆ Din(11) (FIG. 4). The 58^{th} polynomial X(58) for Dout(50) is Dout (56) and is identified as item 71 from bits 68. The value of Dout(56) is loaded into new seed register NS(7).

This procedure is applied to each bit in the array of input bits for a current clock period. Any scramble polynomial can be applied to any length array of parallel bits to generate an array of scrambled output bits during the same clock period.

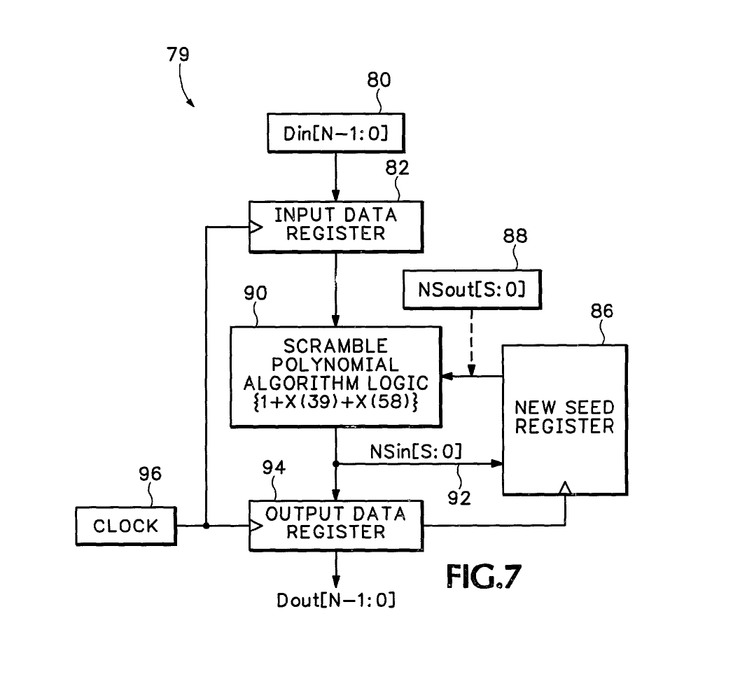

Referring to FIG. 7, a N-bit parallel data de-scrambler 79 is similar to the scrambler shown in FIG. 2. The de-scrambler 79 includes an input data register 82, scrambling logic 90, new seed register 86, and an output data register 94. The scrambled parallel input data stream 80 is loaded into the input data register 82 at the rising edge of a current clock period generated by the clock circuit 96. During a next clock period, the de-scrambling circuit 90 de-scrambles every bit of the scrambled parallel data bus 80 with the de-scrambling polynomial 1+X(39)+X(58) using the parallel input data from data register 82 and the pre-loaded new seed values pre-loaded into the new seed register 86 during a previous clock period.

At the rising edge of the current clock period, the de-scrambled parallel data stream from de-scrambler circuit 90 is loaded into the output data register 94. At the same time, a new set of seed values 92 are loaded from the de-scrambler 90 into the new seed register 86 and another new set of parallel input data 80 is loaded into the input data register 82.

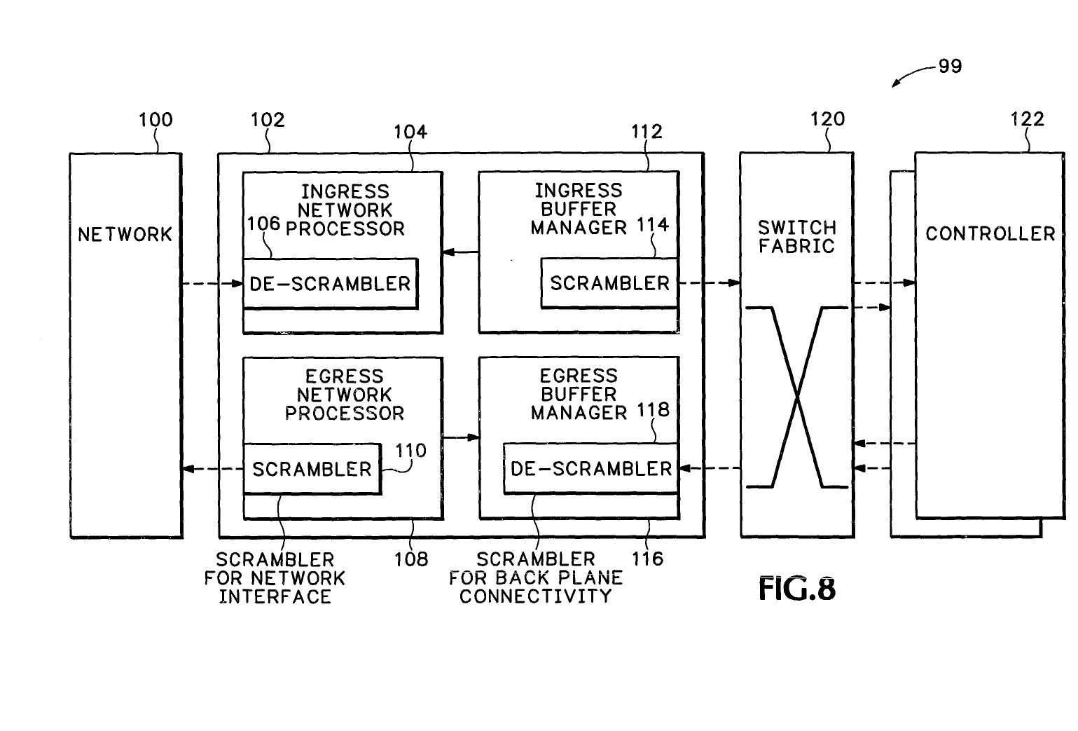

FIG. 8 shows one example of how the parallel scrambler and de-scrambler circuits are implemented in a network processing device 99. In one example, the network processing device 99 is a high speed gigabit router, however, it should be understood that the scrambler scheme can be used in any data processing device. The network processing device 99 includes packet processing circuitry 102 that is coupled to a network 100. The network 100 can be any local or wide area network, such as a Local Area Network (LAN), Wide Area Network (WAN), Metropolitan Area Network (MAN), etc.

The packet processing circuitry 102 includes an ingress network processor 104 that receives network packets from network 100. A de-scrambler circuit 106 makes up part of the ingress network processor 104 and de-scrambles packets as described above in FIG. 7. The de-scrambled bits from the network packets are sent to an ingress buffer manager 112 that includes a scrambler circuit 114 as shown above in FIG. 2. The scrambler circuit 114 scrambles the array of packet bits before they are output by the ingress buffer manager 112 to a switch fabric 120.

Controllers 122 determine the egress ports where the switch fabric 120 transfers the scrambled bits. The egress buffer manager 116 includes a de-scrambler circuit 118 that de-scrambles arrays of the packet bits scrambled by scrambler 114. A scrambler circuit 110 in the egress network processor 108 then scrambles the array of packet bits before being output on network 100.

The system described above can use dedicated processor systems, micro controllers, programmable logic devices, or microprocessors that perform some or all of the scrambling and de-scrambling operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or described features can be implemented by themselves, or in combination with other operations in either hardware or software.

Having described and illustrated the principles of the invention in a preferred embodiment thereof, it should be apparent that the invention may be modified in arrangement and detail without departing from such principles. Claim is made to all modifications and variation coming within the spirit and scope of the following claims.

1. A data scrambler, comprising:
a scrambler device configured to scramble a parallel array of input bits into an array of scrambled output bits all during a same current clock period.

2. A data scrambler according to claim 1 including a new seed register for storing the scrambled output bits from a previous clock period and supplying the scrambled output bits to the scrambler device for applying to the parallel array of input bits during the current clock period.

3. A data scrambler according to claim 1 wherein the scrambler device generates an array of polynomial values for applying to the parallel array of input bits by feeding back an array of scrambled output bits generated during a previous clock period.

4. A data scrambler according to claim 3 including a seed register for storing the array of scrambled output bits.

5. A data scrambler according to claim 3 wherein the scrambler device selects the scrambled output bits for applying to each one of the input bits according to a polynomial value, a bit length for the parallel array of input bits, and a position of the input bits in the parallel array.

6. A data scrambler according to claim 1 wherein a 1+X(39)+X(58) scramble polynomial is applied to each bit of the parallel array of input bits according to the following:
Dout[0:38]=NS[38:0]ˆ NS[57:19]ˆ Din[0:38];
Dout[39:57]=NS[18:0]ˆ NS[38:20]ˆ NS[57:39]ˆ Din[0:18]ˆ Din[39:57]; and
Dout[58:N]=NS[19:14]ˆ NS[57:52]ˆ Din[0:5]ˆ Din[19:24]ˆ Din[58:63]; where, Dout are the scrambled output bits generated during the current clock period, Din are the input bits, NS[57:0]=Dout′[M:N], M=N−58, N=64, and Dout′ are the scrambled output bits generated during a previous clock period.

7. A data scrambler according to claim 2 including an input data register configured to output the parallel array of input bits to the scrambler device and an output data register for receiving the array of scrambled output bits from the scrambler device.

8. A data scrambler according to claim 1 wherein an output of the scrambler device is coupled to both the output data register and the new seed register and an output of the new seed register is coupled to the scramble device.

9. A data scrambler according to claim 1 including an ingress buffer manager that uses the scrambler device to scramble the array of input bits from network packets transferred over a switch fabric.

10. A data scrambler according to claim 1 including an egress network processor that uses the scrambler device to scramble the array of input bits from network packets sent over a network.

11. A method for scrambling data, comprising:
receiving a parallel array of input bits;
storing an array of previously scrambled output bits from a previous clock period; and
applying the array of previously scrambled output bits to the parallel array of input bits during a same current clock period to generate a current array of scrambled output bits.

12. A method according to claim 11 including storing the previous scrambled output bits from the previous clock period as new seed values for applying scramble polynomials to each of the parallel array of input bits during the same current clock period.

13. A method according to claim 12 including selecting the new seeds values according to scramble polynomial values, a bit length of the parallel array of input bits, and a position of the individual bits in the parallel array of input bits.

14. A method according to claim 11 including using the stored array of previously scrambled output bits to apply a 1+X(39)+X(58) scramble polynomial to each one of the parallel array of input bits during the same current clock period.

15. A method according to claim 11 including:
receiving a parallel array of scrambled input bits;
storing an array of previously de-scrambled output bits de-scrambled during a previous clock period; and
applying the array of previously de-scrambled output bits to the parallel array of scrambled input bits during a same current clock period to generate a current array of de-scrambled output bits.

16. A method according to claim 15 including storing the current array of de-scrambled output bits as new seed values for applying to a next parallel array of scrambled input bits during a next clock period.

17. A method according to claim 11 including:
scrambling the parallel array of input bits for network packets in a network router;
transferring the network packets over a switch fabric in the network router; and
de-scrambling the scrambled parallel array of input bits received over the switch fabric.

18. A method according to claim 11 including:
de-scrambling a parallel array of scrambled packet bits received over a network; and
scrambling parallel arrays of de-scrambled packet bits during the same clock period before sending the packet bits over the network.

19. A network processing device, comprising:
an ingress circuit configured to process packets received over a network;
an egress circuit configured to process packets for sending over the network;
a switch fabric for transferring packets between the ingress circuit and the egress circuit; and
a scrambler circuit configured to scramble a parallel array of packet bits into an array of scrambled output bits during a same current clock period.

20. A network processing device according to claim 19 including a new seed register for storing an array of scrambled output bits from a previous clock period and supplying the array of scrambled output bits to the scrambler circuit for applying to the parallel array of packet bits during the current clock period.

21. A network processing device according to claim 20 including a first scrambler circuit and new seed register located in the ingress circuit for scrambling the array of packet bits before being transferred over the switch fabric and a second scrambler circuit and new seed register located in the egress circuit for scrambling the array of packet bits before being transferred over the network.

22. A network processing device according to claim 20 including a de-scrambler circuit configured to de-scramble the array of scrambled packet bits into an array of de-scrambled packet bits during a same current clock period.

23. A network processing device according to claim 22 including a de-scrambler new seed register for storing an array of de-scrambled packet bits from a previous clock period and supplying the array of de-scrambled output bits to the de-scrambler circuit for applying to the scrambled packet bits during the current clock period.

24. A network processing device according to claim 23 including a first de-scrambler circuit and de-scrambler new seed register located in the ingress circuit for de-scrambling arrays of packet bits after being received from the network and a second de-scrambler circuit and new seed register located in the egress circuit for de-scrambling arrays of scrambled packet bits received over the switch fabric.
